(19) United States
(12) Patent Application Publication
(10) Pub. No.: US 2002/0021408 A1
(43) Pub. Date: Feb. 21, 2002

(54) Spectacles

(76) Inventor: Ewan McClure, Auchencaim (GB)

Correspondence Address: Robert E. Muir, Husch & Eppenberger, LLC, 401 Main Street, Suite 1400, Peoria, IL, 61602-1241, US

(21) Appl. No.: 09/838,503

(22) Filed: Apr. 19, 2001

(30) Foreign Application Priority Data
Apr. 20, 2000 (GB) GB0009695.8

(51) Int. Cl. G02C 7/02

(52) U.S. Cl. 351/159

(57) ABSTRACT

The present application describes a distortion device that can be applied to the lenses of a pair of spectacles, the distortion devices providing a distorted image to a user of the spectacles. The spectacles can be used to create works of art such as paintings by inhibiting the natural preconceptions of the artist in terms of color and shape. The application also describes a method of creating a painting whereby different spectacles provided with different distortion devices are worn in progressive stages, the distortion devices presenting the artist with less distorted images at each stage.

### BACKGROUND OF THE INVENTION

The present invention relates to spectacles and in particular it relates to spectacles (“glasses”) with distorted lenses to be used by an artist while painting.

When an artist paints a realistic representation of the visible world through an objective study of natural color and form, the technique is described, broadly, as naturalistic. This naturalistic technique demands the ability to see the object to be painted with no regard to visual or psychological distractions. The artist must paint what they see, rather than what they expect to see, that is, they must paint what is seen rather than what is known. Any intellectual preconceptions will tend to distract from the actual colors and shapes presented by the subject to be painted.

For example, a lawn in bright sunlight might reflect yellow rays of light into the artist's eye. However, the artist might be inclined to select green paint, having his perceptions influenced by having learned that grass is green. To see with the desired innocence, he must somehow override his intellectual preconceptions.

There is a well-established practice of “squinting” or half-shutting the eyes to help perceive these broader visual facts. This may be uncomfortable for the artist and may strain his/her eyes, particularly during a long painting session.

### SUMMARY OF THE INVENTION

According to a first aspect of the present invention there is provided a distortion device that distorts light passing therethrough so that a correspondingly blurred image is observed by a user of the distortion device.

Typically, the distortion device is provided for use with a lens that may be provided in or for a contact lens, a monocle, or a pair of spectacles. Typically, the visual device is for use by an artist to aid in the creation of a painting. The distortion device is typically a visual distortion device.

Optionally, the distortion device comprises a translucent film attached to a lens. This has the advantage in that the spectacles are relatively cheap to produce, and they do not have the tendency to deteriorate the user's own eyesight.

The film may be textured. The film may be similar to the transparent material used to store or hold photographic prints or slides.

Alternatively, the distortion device may be intrinsic to the lens itself.

Typically, the spectacles further comprise a frame that holds two distortion devices, each of which distorts light passing therethrough.

The distortion device may be non-magnifying although magnifying distortion devices may be used if required by the individual user. Non-magnification has the advantage of not being detrimental to the user's eyesight.

In accordance with a second aspect of the invention there is provided a set of at least two visual devices like a set of two pairs of spectacles, each being in accordance with the first aspect of the invention.

Typically there are three lenses or distortion devices in the set.

Preferably, the first lens or distortion device in e.g. the first pair of spectacles creates the most blurred effect. Typically, the user wears the first spectacles to start a painting. Colors may then be selected purely on what is seen through the blurred glasses rather than learned relationships between subjects and color. Typically, a second pair of spectacles is then worn instead of the first, the second spectacles being provided with a second distortion device that distorts to a lesser extent than that of the first spectacles. This second spectacles preferably distort the image to a lesser extent than the first spectacles and more detail and colors may be added to the painting. One or more subsequent pairs of spectacles may then be worn in turn, each pair being provided with a distortion device that is typically progressively less blurred than the previous pair. As each pair is worn, more detail is typically added to the painting. Optionally, as a final stage the painting may be completed without spectacles.

The degree of distortion can be approximately quantified by measuring the “scatter” effect on a laser beam passed through each of the three distortion samples from a fixed distance. In one embodiment, the distance between a laser source and a screen is 500 mm, the distance between each sample lens and the screen is 450 mm, and a most distorted lens typically produces a laser spot of around 15 to 20 mm in diameter. A lens of an intermediate distortion typically produces a laser spot of around 6 to 8 mm in diameter, and a lens of minimum distortion typically produces a laser spot of 4 to 5 mm diameter. The diameter of the laser spot on screen may be around 1 to 2 mm without any lenses.

In accordance with a third aspect of the present invention, there is provided a method of creating a work of art, the method comprising wearing a visual device in accordance with the first aspect of the invention during the creation of the painting.

In accordance with a fourth aspect of the present invention, there is provided a method of painting, the method comprising wearing each of a set of visual devices in accordance with the second aspect of the invention at separate intervals during the creation of the painting.

In accordance with a fifth aspect of the invention there is provided a method of facilitating the creation of artwork, the method comprising providing a distortion device in the field of vision of a creator of the art work.

### BRIEF DESCRIPTION OF THE DRAWINGS

Embodiments of the present invention shall now be described, by way of example only, and with reference to the accompanying drawings, in which:

FIG. 1 is a front elevation of a pair of spectacles or glasses;

FIG. 2 is a front elevation of a monocle; and

FIGS. 3a, b and c show side views of films that are suitable for being applied to spectacles or monocles with conventional lenses.

### DETAILED DESCRIPTION

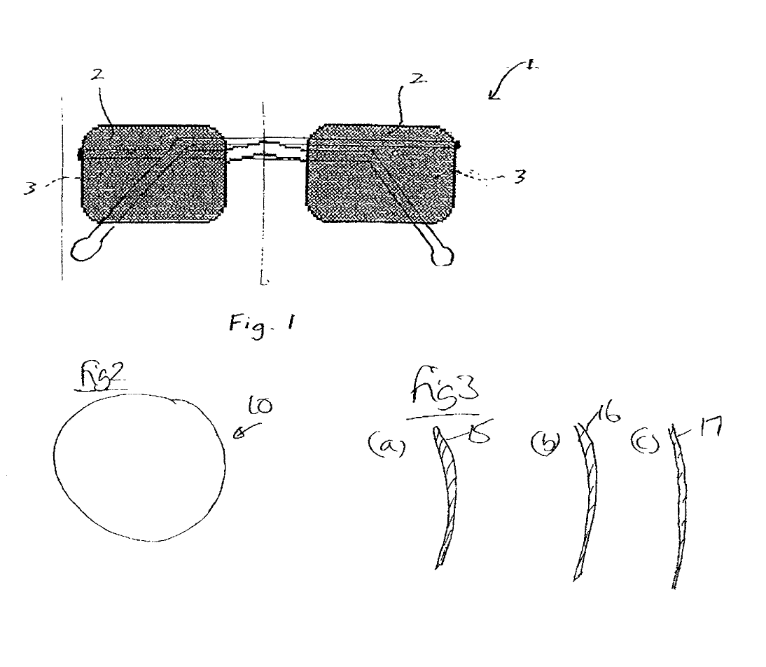

Referring to the drawings, FIG. 1 shows a pair of glasses or spectacles 1. The glasses 1 include two lenses 3 provided with distortion devices that in this embodiment comprise a thin translucent coating or surface texture 2 applied to each lens 3. This can be an intrinsic texture applied during the making of the lenses or can be a textures film 15, 16, 17 as shown in FIG. 3, which can be applied retrospectively to any visual device.

All of the methods of use herein described can be applied to monocles 10 as shown in FIG. 2 as well as to spectacles 1 and contact lenses.

The glasses 1 or monocle 10 can be used by a painter while he is creating a painting to provide a more naturalistic painting. In this example, three pairs of glasses are used in the course of creating the painting. The first pair of glasses 1, as shown in FIG. 1, has a high degree of distortion due to the thin film 2.

Each pair of glasses has been created by modifying conventional glasses (as used for optical correction) by attachment of the thin translucent film 2 over each lens 3. In this example, the same film is used on both lenses 3 in the pair. The type of film 15 used is from an Ofrex polypocket for an A4 ringbinder in the first pair 1. The type of film 16 used in the second pair is from a Kenro ringbinder storage page for 8″×10″ photographic prints (order number KEN 009), and the film 17 used in the third pair is from a Kenro ringbinder storage page for 35 mm slides (order number KEN016).

It is to be understood that the invention is not limited to such film and the distortion may be achieved by using other materials. Alternatively, the distortion may be provided by the lens 3 intrinsically with no film attached. That is, the lens 3 may be manufactured to distort the light entering it.

For example, the lens 3 may be precision molded into molten glass using direct pressing equipment. By this means, the lens 3 can be created with a wide range of textures corresponding to precise degrees of light distortion.

Each pair of glasses has lenses with a different degree of distortion compared to that of the others. The glasses having the first film 15 have the highest degree of distortion and are worn for the first stage of the painting process. The subject appears as a pattern of broad mists of color to the artist, and the pattern is faithfully recreated on canvas by the artist, matching one color to the next.

When the artist has achieved a match between the subject and the painting as seen through the first glasses with the film 15, he changes to the second, less distorted pair of glasses having the film 16. Now, more small areas of color modulation will be seen in the subject as compared to the relatively flat areas of color on the canvas, but the positions of these new details are easily located within the color spots of the first stage created using glasses with the film 15.

When the necessary modifications of the second stage are complete, the image will be close to completion. The third glasses with the film 17 are then used to make final refinements, without getting too “tight”; that is to say, without picking out the detail too finely. These glasses provide a further controlled step towards detail, while continuing to generalize distracting surface qualities that would inhibit the free movement of the brush.

Finally, with no glasses at all, the painting is given its final assessment, and last refinements are made if necessary. The process could be repeated any number of times with any number of different glasses that are provided with different films on the lenses 2, each pair providing an image to the artist that is progressively less distorted.

The spectacles are intended for use in a step-by-step painting method where different degrees of “scattering” or “distortion” are required. Therefore, three graded textures are selected to suit the particular requirements of the consecutive stages of the method. It will be appreciated that more than three different grades of texture and/or distortion may be used.

The three values have been roughly quantified by measuring the “scatter” effect on a laser beam passed through each of the three samples from a fixed distance. As an example, three different pairs of spectacles with three different distortion devices e.g. films 15, 16, and 17 were used. The distance between the laser source and screen was 500 mm. The distance between each sample lens and the screen was 450 mm. The most distorted film 15 would produce a laser spot of around 15 to 20 mm. A film 16 of an intermediate distortion would produce a laser spot of around 6 to 8 mm in diameter. A film 17 of minimum distortion would produce a laser spot of around 4 to 5 mm in diameter. As a reference, the diameter of the laser spot on screen would be around 1 to 2 mm without any lenses.

If the artist is long or short sighted, the distorting glasses are intended to he used in conjunction with contact lenses or normal glasses, to avoid an exaggerated effect.

The spectacles remove distracting details and reduce the effect of the artist's inhibitions that encourages a bold, energetic approach. To an observer without the glasses, such fluent application may seem reckless, but recognizable form emerges surprisingly quickly, simply because of the accuracy of the color relationships.

It will be appreciated that instead of using different pairs of glasses with different distortion devices (e.g. films) the same pair of glasses could be used where the film or lenses can be removed and replaced with different film or lenses

Modifications and improvements may be made to the foregoing without departing from the scope of the invention.

What is claimed is:

1. A distortion device that distorts light passing therethrough so that a correspondingly blurred image is observed by a user of the distortion device.

2. The distortion device according to claim 1, wherein the distortion device comprises a lens having an inherent capacity for visual distortion.

3. The distortion device according to claim 2, wherein a texture is pressed into the lens during manufacture.

4. The distortion device according to claim 1, wherein the device is a film adapted for attachment to a lens.

5. The distortion device according to claim 4, wherein the film is textured.

6. The distortion device according to claim 1, wherein the device is made up into a visual device selected from the group comprising contact lenses, monocles and spectacles.

7. The distortion device according to claim 6, wherein the visual device comprises a frame that holds at least one distortion device to distort light, passing therethrough.

8. The distortion device according to claim 3, wherein at least one of the lens and the distortion device is magnifying.

9. A visual device having first and second distortion devices that distort light passing therethrough so that a correspondingly blurred image is observed by a user of the visual device.

10. A visual device as claimed in claim 9, wherein the first and second distortion devices are interchangeable on the same visual device and are adapted to be used sequentially by the user of the visual device.

11. The visual device according to claim 9, selected from the group consisting of contact lenses, monocles and spectacles.

12. The visual device according to claim 9, wherein a third distortion device is provided.

13. A visual device according to claim 9, wherein the first and second distortion devices distort light to different extents.

14. A visual device according to claim 9, wherein the first distortion device distorts light to a greater extent than the second distortion device.

15. A visual device according to claim 12, wherein the third distortion device distorts light to a lesser extent than the first and second distortion devices.

16. A method of creating a work of art, the method comprising the steps of wearing a visual device comprising a distortion device that distorts light passing therethrough so that a correspondingly blurred image is observed by a user of the spectacle, and creating the work of art while looking at a subject through the visual device.

17. A method according to claim 16, wherein the method includes the additional steps of wearing a second visual device comprising a second distortion device having a lower level of distortion than the first distortion device; and modifying the work of art as viewed through the second device.

18. The method according to claim 17, wherein the method includes the additional steps of wearing a third visual device comprising a third distortion device having a lower level of distortion than the second distortion device; and modifying the work of art as viewed through the third visual device.

19. The method according to claim 17, wherein the method includes the additional steps of removing all visual devices and modifying the work of art as viewed without any visual devices.

20. A method according to claim 16, wherein the work of art is a painting in color.
